(19) United States
(12) Patent Application Publication
(10) Pub. No.: US 2020/0141787 A1
(43) Pub. Date: May 7, 2020

(54) CAPACITIVE LEVEL SENSOR FOR LIQUIDS WITH FOAMING AGENT IN TANKS

(71) Applicant: CEBI ELECTROMECHANICAL COMPONENTS SPAIN, S.A., VILLATUERTA (NAVARRA) (ES)

(72) Inventors: Javier Garcia Izaguirre, Lardero (La Rioja) (ES); Sergio Diez Garcia, Obanos (Navarra) (ES); Jorge Machin Mindan, Pamplona (Navarra) (ES)

(21) Appl. No.: 16/672,891

(22) Filed: Nov. 4, 2019

(30) Foreign Application Priority Data
Nov. 7, 2018 (ES) U201831706

(51) Int. Cl. G01F 23/26

(52) U.S. Cl. CPC G01F 23/265

(57) ABSTRACT

The invention relates to a capacitive level sensor for liquids with foaming agent in tanks, having a sensor element to establish physical contact with the liquid that can be deposited in a tank and generate a signal as a function of the physical contact, a control unit configured to receive the signal that can be generated by the sensor element and carry out a determination concerning the presence of liquid as a function of the signal, and a main body for housing the control unit, avoiding contact with the liquid. The invention is characterized in that it additionally has a surrounding structure configured to be arranged surrounding the sensor element inside the tank; such that the surrounding structure is available, acting as a separation element between the sensor element and the foam that can be generated from the liquid.

### CROSS-REFERENCE TO RELATED APPLICATION

This application claims the benefit of priority from Spanish Patent Application No. U201831706, filed Nov. 7, 2018, which is incorporated herein by reference.

### TECHNICAL FIELD

The present invention relates to the industry dedicated to capacitive level sensors to detect the presence and levels of liquids collected in tanks, the liquids being those which include foaming agent, that is to say with the capacity to cause foam to be formed.

### STATE OF THE ART

At present, the need to detect the presence of liquid in areas with a tendency or predisposition to accumulate the same is well-known, such as for example in tanks for fuel, cooling liquid, windscreen wiper liquid, etc.

Similarly, capacitive level sensors are widely known which consist of a detection element, such as for example a rod or probe, intended to be located in tanks or locations where liquid accumulates for the purpose of determining whether or not there is liquid.

However, the known capacitive level sensors exhibit the serious problem of detecting the presence of liquid, foam being contacted by means of the detection element. In these cases, it is impossible to distinguish the contact of the detection element with the foam at the level of the conditioning electronics of the signal generated by the probe. This generates an undesired detection of the liquid which may result in the stopping of machines, motor vehicles, motorcycles, etc.

In addition, these false or erratic detections of liquid entail economic costs as it requires displacement of the machine or vehicle, which has the capacitive level sensor to detect the presence of liquid installed, to a garage or similar, subsequent removal and possible changing of the sensor, not also being required.

In view of the described disadvantages which the existing solutions exhibit at present, it is evident that a solution is needed which prevents the detection of foam resulting in an interpretation of the presence of liquid.

### OBJECT OF THE INVENTION

For the purpose of meeting this objective and solving the technical problems discussed up until now, in addition to providing additional advantages that may be derived below, the present invention relates to a capacitive level sensor for liquids with foaming agent in tanks.

The capacitive level sensor comprises a sensor element to establish physical contact with the liquid that can be deposited in the tank and generate a signal as a function of the physical contact; a control unit configured to receive the signal that can be generated by the sensor element and carry out a determination concerning the presence of liquid as a function of the signal; and a main body for housing the control unit, avoiding contact with the liquid.

The capacitive level sensor also comprises a surrounding structure, preferably of a plastic material, configured to be arranged surrounding the sensor element inside the placement tank. In this way, the surrounding structure is available, acting as a separation element between the sensor element and the foam that can be generated from the liquid.

The surrounding structure preferably has a longitudinal extension, that is to say, is elongated and has a tubular configuration. The surrounding structure is preferably configured so as it can be placed in the tank by means of insertion.

The surrounding structure has a first end for placement in the tank, the surrounding structure having at the first end perimeter tabs to be arranged fitted in the tank.

The surrounding structure has a longitudinal dimension defined for being arranged, extending from a first point of the corresponding tank to a second point geometrically opposed to the first point.

The surrounding structure has a second end available inside the tank and the longitudinal dimension is defined such that the second end is close to a second face of the tank. Alternatively, the longitudinal dimension is defined to establish a contact between the second end and an internal part of the second face.

The capacitive level sensor can comprise a passage limiting element, the passage limiting element having passage holes dimensioned for passage of liquid and blocking the passage of foam. The passage limiting element is preferably configured in the manner of a net or lattice.

The capacitive level sensor can also comprise a watertight seal arranged for fixed and watertight placement of the main body (3) in the corresponding placement tank.

The capacitive level sensor can also comprise a fastening element for fastening the surrounding structure inside the placement tank of the sensor.

### BRIEF DESCRIPTION OF THE FIGURES

FIG. 1 shows a schematic perspective view of a capacitive level sensor for liquids with foaming agent in tanks object of the invention, arranged in a tank and having a surrounding structure comprised in the sensor itself.

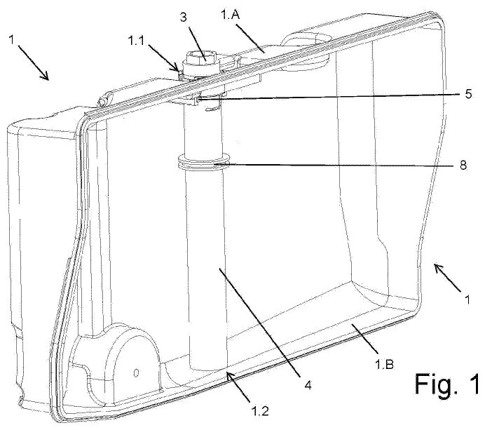

FIG. 2 shows a schematic perspective view of the capacitive level sensor for liquids with foaming agent in tanks, arranged in the tank and without having the surrounding structure.

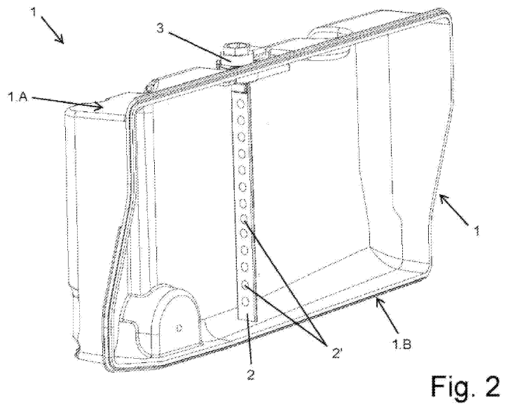

FIG. 3 shows a schematic perspective view of the capacitive level sensor for liquids with foaming agent in tanks without having the surrounding structure.

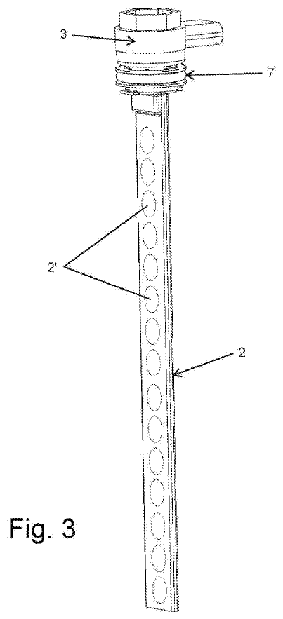

FIG. 4 shows a schematic view of the surrounding structure.

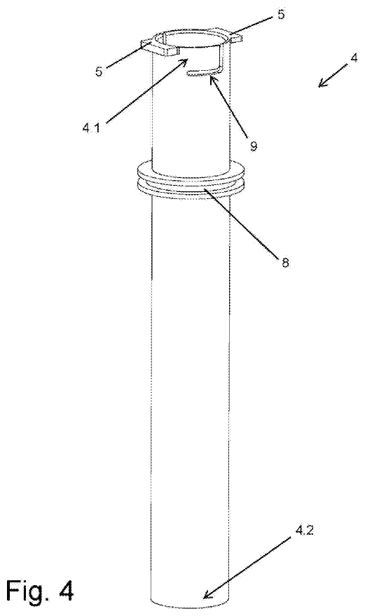

FIG. 5 shows another schematic view of the surrounding structure, a passage limiting element comprised in the capacitive level sensor for liquids with foaming agent being visible.

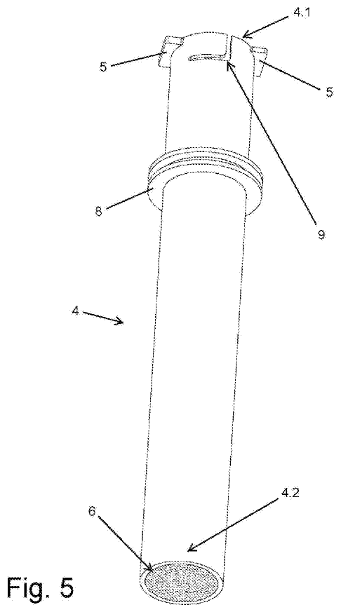

### DETAILED DESCRIPTION OF THE INVENTION

The present invention relates to a capacitive level sensor for liquids with foaming agent in tanks (1). The tank (1) for placement of the sensor is preferably considered a tank for fuel, cooling liquid, windscreen wiper liquid, etc., although any element that can accumulate liquid may also be considered, that is to say reservoirs, recipients, etc. The tank (1) is not object of the present invention.

The present capacitive level sensor for liquids comprises a sensor element (2) intended to establish contact with the liquid that can be deposited in the corresponding placement tank (1) and generate a signal as a function of said contact or detection.

The sensor element (2) preferably has a set of detection points (2′) distributed longitudinally along the same. Alternatively, the sensor element (2) can have a single detection point (2) extending longitudinally along the same. In both cases, the probabilities of contact with the liquid are increased and it allows more than one accumulation level of the liquid in the tank (1) to be established.

Additionally, the capacitive level sensor comprises a main body (3), to be arranged in an external part of the cited tank (1) and a control unit, the control unit being located in the main body (3) such that contact between the liquid and the control unit is prevented.

The control unit, not shown for reasons of clarity, is configured to receive the signal that can be generated by the sensor element (2). For this purpose, the capacitive level sensor preferably comprises a cable arranged to establish an electric connection between the sensor element (2) and the control unit. Additionally, the control unit is configured to carry out a determination concerning the presence of liquid in the tank (1) as a function of said signal.

The present capacitive level sensor for liquids also comprises a surrounding structure (4), with a longitudinal extension and tubular configuration for being arranged surrounding the sensor element (2) inside the tank (1).

The cited surrounding structure (4), preferably made of a plastic material, has ends, a first end (4.1) for being placed in the tank (1) and a second free end (4.2), longitudinally opposed to the placement end (4.1). The surrounding structure (4) has at the first end (4.1) perimeter tabs (5) for being arranged fitted in the tank (1).

In this way, the surrounding structure (4) acts as a separation element between the sensor element (2) and the foam that can be generated from the liquid with foaming agent, preventing false determinations of the presence of liquid by contact of the sensor element (2) with said foam.

In addition, the surrounding structure (4) is longitudinally dimensioned such that, being placed in the tank (1), said structure (4) extends from a first point (1.1) of the tank (1) to a second point (1.2) geometrically opposed to the first point (1.1).

The surrounding structure (4) is preferably configured so as to be placeable in the corresponding tank (1), preferably by means of insertion, in correspondence with a first face (1.A) of the tank (1). To this end, for example, said structure (4) lacks projections projecting externally and radially. In accordance with this, the first point (1.1) is located on the first face (1.A) of the tank (1) and the second point (1.2) on a second face (1.B) which is opposed to the first (1.A).

In this way, the surrounding structure (4) has the second end (4.2) intended to be arranged inside the tank (1) and therefore in contact with the liquid that can be deposited in the same.

The surrounding structure (4) is longitudinally dimensioned such that, the surrounding structure (4) being placed in the tank (1), the second end (4.2) is preferably close to the second face (1.B) of the tank (1). In this way, the sensor element (2) comprised in the capacitive level sensor for liquids can practically be as long as the tank (1) in question allows, that is to say practically as long as the separation between the first face (1.A) and the second face (1.B) allows.

More preferably, the surrounding structure (4) being placed in the tank (1), the surrounding structure (4) is longitudinally dimensioned such that the second end (4.2) is in contact with an internal part of the second face (1.B) of the tank (1). In this way, the length of the sensor element (2) is maximised to the greatest possible extent. Additionally, this arrangement of the second end (4.2) blocks or limits to a large extent the passage of the foam that can be generated in the tank (1) to a space comprised between the surrounding structure (4) and the sensor element (2).

That is to say, when the tank (1) is almost empty, or empty, foam is formed without there hardly being liquid, for example pouring firstly detergent as liquid with foaming agent and then water, the foam is prevented to a large extent from reaching and contacting the sensor element (2), given the zero, or practically zero, accessibility available to said space between the surrounding structure (4) and the sensor element (2) by way of the second end (4.2) of the surrounding structure (4).

With these arrangements of the second end (4.2), both close to and especially in contact with the second face (1.B) of the tank (1), the false determination of the presence of liquid by contact of the sensor element (2) with foam is clearly minimised, possibly even being eliminated or distinguished given the reduced increase in the level of liquid that can be provided due to the little or zero foam available in the space between the surrounding structure (4) and the sensor element (2).

With the aim of completely eliminating the passage of foam that can be generated to said space between the surrounding structure (4) and the sensor element (2) by way of the second end (4.2), the capacitive level sensor for liquids also comprises a passage limiting element (6) arranged covering, capping or closing the second end (4.2) of the surrounding structure (4).

The passage limiting element (6) of fluids has passage holes of dimensions such that it allows the passage of liquids but prevents or blocks the passage of foam. That is to say, said passage limiting element (6) is configured to prevent the passage of the foam whilst allowing the passage of liquid. Thus, the passage limiting element (6) is configured in the manner of a net or lattice.

Said passage limiting element (6) is preferably a piece available in a removable manner at the second end (4.2), although alternatively it can be a piece arranged in a fixed manner, forming a unit with the surrounding structure (4).

The present capacitive level sensor for liquids also comprises a watertight seal (7) arranged for watertight placement of the main body (3) on the first face (1.A) of the tank (1.A).

Similarly, the capacitive level sensor for liquids also comprises a fastening element (8) for fastening the surrounding structure (4) on a point longitudinally distanced with respect to the watertight seal (7) for the purpose of providing firmness in the fastening thereof in the tank (1). Said fastening element (8) may be an integral part of the surrounding structure (4) or an independent element arranged in said surrounding structure (4).

Additionally and preferably, the capacitive level sensor for liquids comprises at least one passage groove (9) and optionally two, in the surrounding structure (4). More specifically, said passage grooves (9) are located in correspondence with the first end (4.1) of the surrounding structure (4). These passage grooves (9) are configured to establish a coupling of the surrounding structure (4) in the corresponding placement tank (1).

The passage grooves (9) provide elasticity or flexibility to the surrounding structure (4) such that they provide the capacity to absorb vibrations. In addition, these passage grooves (9) have, in fluid communication, an internal part and an external part of the surrounding structure (4).

1. A capacitive level sensor for liquids with foaming agent in tanks, comprising:
a sensor element to establish physical contact with the liquid that can be deposited in a tank and generate a signal as a function of the physical contact;
a control unit configured to receive the signal that can be generated by the sensor element and carry out a determination concerning the presence of liquid as a function of the signal; and
a main body for housing the control unit, avoiding contact with the liquid; comprising:
a surrounding structure configured to be arranged surrounding the sensor element inside the tank, such that the surrounding structure is available, acting as a separation element between the sensor element and the foam that can be generated from the liquid.

2. The capacitive level sensor according to claim 1, wherein the surrounding structure has a first end for placement in the tank, the surrounding structure having at the first end perimeter tabs to be arranged fitted in the tank.

3. The capacitive level sensor according to claim 1, wherein the surrounding structure has a second end available inside the tank and a longitudinal dimension defined such that the second end is close to a second face of the tank.

4. The capacitive level sensor according to claim 3, wherein the longitudinal dimension is defined to establish contact between the second end and an internal part of the second face.

5. The capacitive level sensor according to claim 1, wherein the surrounding structure is configured to be placed in the tank by means of insertion.

6. The capacitive level sensor according to claim 1, further comprising a passage limiting element, the passage limiting element having passage holes dimensioned for passage of liquid and blocking the passage of foam.

7. The capacitive level sensor according to claim 6, wherein the passage limiting element is configured in the manner of a net or lattice.

8. The capacitive level sensor according to claim 1, further comprising a watertight seal arranged for fixed and watertight placement of the main body in the tank.

9. The capacitive level sensor according to claim 1, further comprising a fastening element for fastening the surrounding structure inside the tank.

10. The capacitive level sensor according to claim 1, wherein the surrounding structure is made of a plastic material.
